(19) United States
(12) Patent Application Publication
(10) Pub. No.: US 2019/0171257 A1
(43) Pub. Date: Jun. 6, 2019

(54) MOUNTING ASSEMBLY

(71) Applicant: HEWLETT PACKARD ENTERPRISE DEVELOPMENT LP, Houston, TX (US)

(72) Inventors: Earl Moore, Cypress, TX (US); Vincent Nguyen, Houston, TX (US)

(21) Appl. No.: 16/271,047

(22) Filed: Feb. 8, 2019

Related U.S. Application Data
(63) Continuation of application No. 15/328,707, filed on Jan. 24, 2017, now abandoned.

(51) Int. Cl. G06F 1/18; A47B 88/49; G11B 33/00

(52) U.S. Cl. CPC G06F 1/187; G11B 33/005; A47B 88/49

(57) ABSTRACT

An example mounting assembly is provided herein. The mounting assembly includes a first cage, a second cage, a rail member, a rigid cable member, a latch member, and a lock mechanism. The rail member to move the first cage and the second cage between an installed position, an access position, and a transitional position. The rigid cable member to move with the first cage and the second cage along the rail member. The latch member to retain the first cage and the second cage in the installed position. The lock mechanism to hold the second cage in the access position.

### BACKGROUND

Computing systems include hard disk drives. The hard disk drives are typically attached to a hard disk drive carrier then inserted into a computing system. For example, a hard disk drive is attached to a hard disk drive carrier and then inserted into a shelf in a computing system where it is connected to other electronic components.

### BRIEF DESCRIPTION OF THE DRAWINGS

Non-limiting examples of the present disclosure are described in the following description, read with reference to the figures attached hereto and do not limit the scope of the claims. In the figures, identical and similar structures, elements or parts thereof that appear in more than one figure are generally labeled with the same or similar references in the figures in which they appear. Dimensions of components and features illustrated in the figures are chosen primarily for convenience and clarity of presentation and are not necessarily to scale. Referring to the attached figures:

FIG. 1 illustrates a block diagram of a mounting assembly 100 according to an example;

FIGS. 2-4 illustrate isometric views of the mounting assembly of FIG. 1 according to an example;

FIG. 5 illustrates a block diagram of a system according to an example;

FIGS. 6-9 illustrate schematic views of the system of FIG. 5 according to examples;

FIG. 10 illustrates a back view of the system of FIG. 5 according to an example; and

FIG. 11 illustrates an isometric view of the front of the system of FIG. 5 according to an example.

### DETAILED DESCRIPTION

In the following detailed description, reference is made to the accompanying drawings which form a part hereof, and in which is depicted by way of illustration specific examples in which the present disclosure may be practiced. It is to be understood that other examples may be utilized and structural or logical changes may be made without departing from the scope of the present disclosure.

Computing system designs determine requirements for components in the computing system. Space, thermal constraints, cost, and ease of use are some factors that determine the type of mounting assemblies and cages used with electronic components, such as hard disk drives.

In examples, a mounting assembly is provided. The mounting assembly includes a first cage, a second cage, a rail member, a rigid cable member, a latch member, and a lock mechanism. The rail member includes a first rail to receive the first cage, a second rail to receive the second cage, and a third rail to connect to a chassis. The rail member to move the first cage and the second cage between an installed position, an access position, and a transitional position. The rigid cable member to move with the first cage and the second cage along the rail member. The latch member to retain the first cage and the second cage in the installed position. The lock mechanism to hold the second cage in the access position.

The phrase “disk drive” refers to a device to read data from and write data to a disk. For example, a hard disk drive uses a program to read data from and write data to a disk.

The phrase “electronic component” refers to a computing device that provides computer solutions, storage solutions, network solutions and/or cloud services.

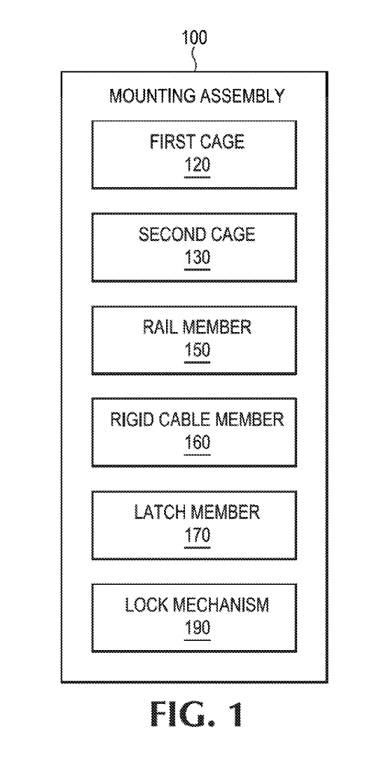

FIG. 1 illustrates a block diagram of a mounting assembly 100 according to an example. The mounting assembly 100 includes a first cage 120, a second cage 130, a rail member 150, a rigid cable member 160, a latch member 170, and a lock mechanism 190. The mounting assembly 100 may mount to a support structure, such as a rack. The first cage 120 and the second cage 130 may receive electronic components, for example, hard disk drives.

The rail member 150 includes a first rail, a second rail, and a third rail. The first rail to receive a first cage 120. The second rail to receive a second cage 130. The third rail to connect to a chassis. The rail member 150 to move the first cage 120 and the second cage 130 therealong between an installed position, an access position, and a transitional position. The rigid cable member 160 to move with the first cage 120 and the second cage 130 along the rail member 150. The latch member 170 to retain the first cage 120 and the second cage 130 in the installed position. The lock mechanism 190 to hold the second cage 130 in the access position.

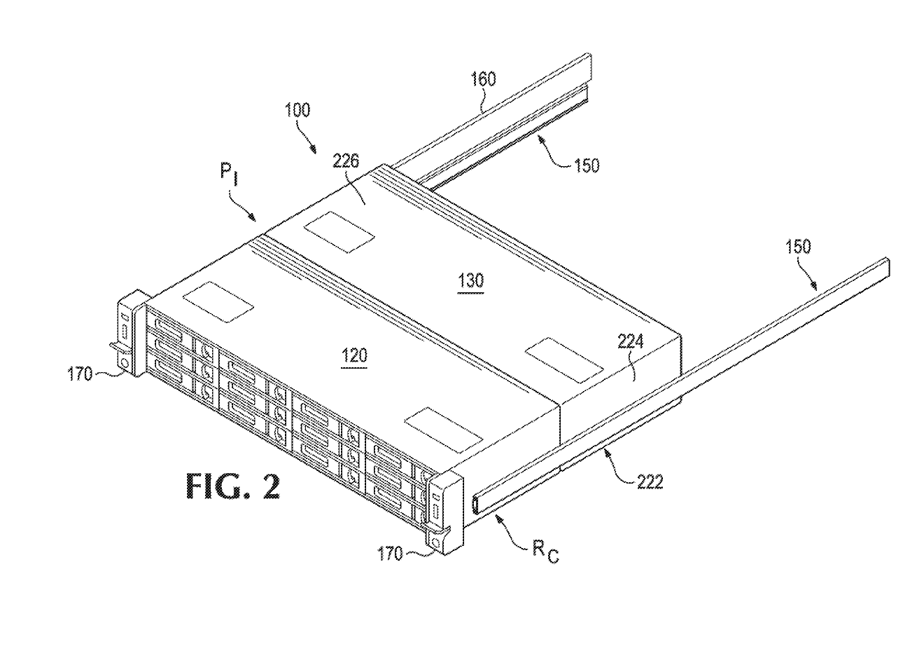

FIGS. 2-4 illustrate isometric views of the mounting assembly 100 of FIG. 1 according to an example. Referring to FIGS. 2-4, the first cage 120, the second cage 130, the rail member 150, the rigid cable member 160, the latch member 170, and the lock mechanism 190 are illustrated. The first cage 120 and the second cage 130 are formed of a cage support structure including a base 222, a top wall 224, and a pair of side walls 226. The first cage 120 and the second cage 130 are connected to one another via the rail member 150.

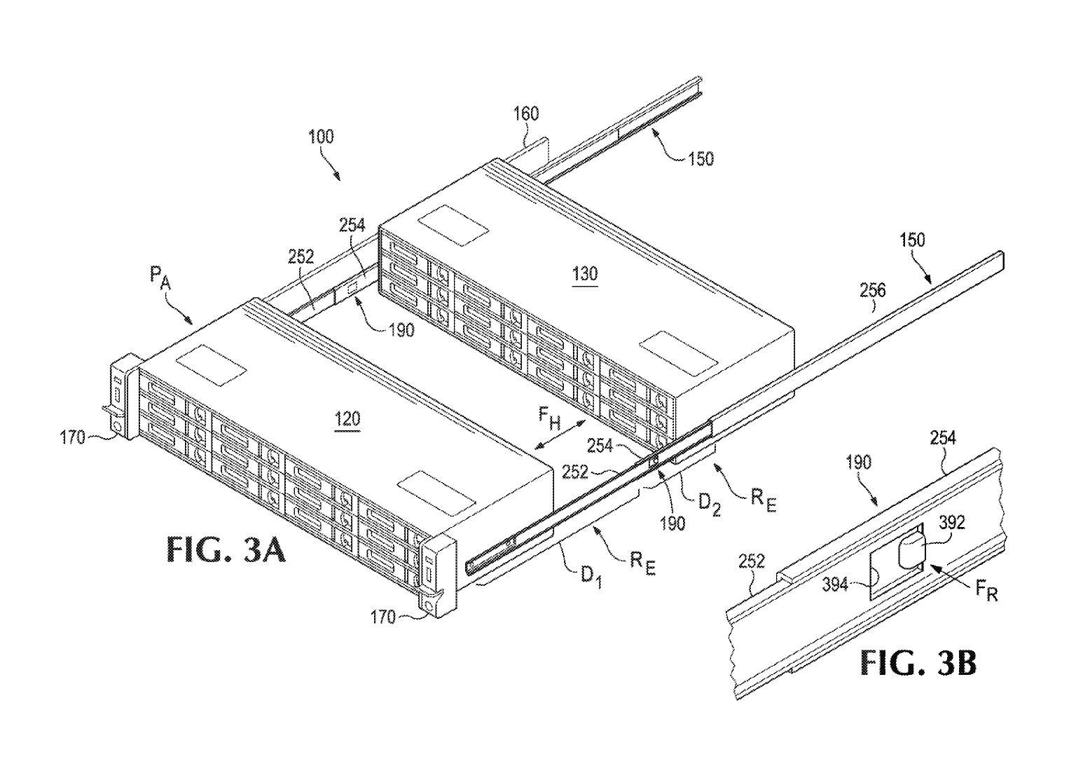

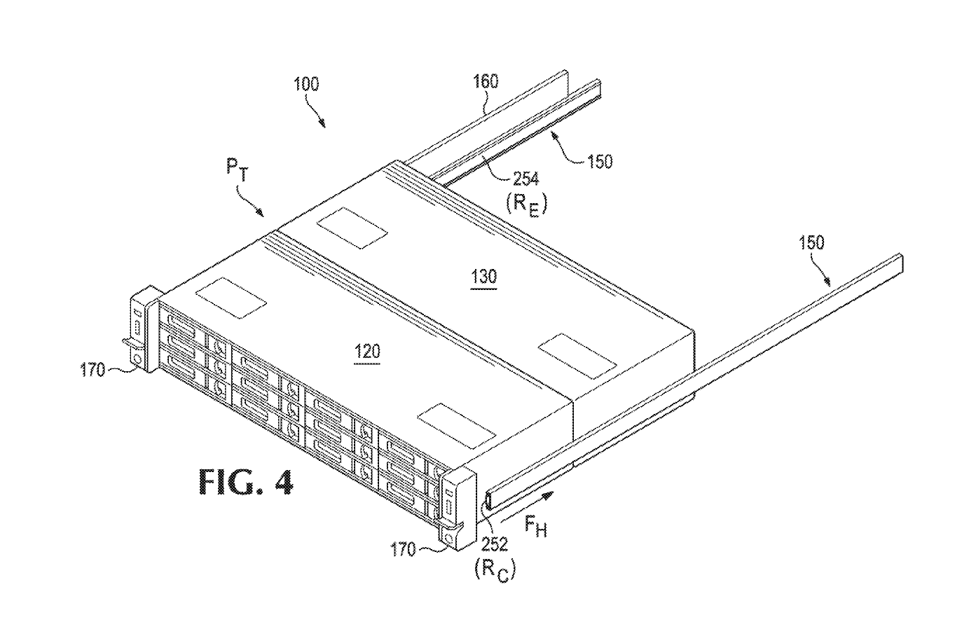

For example, the rail member 150 may be a telescoping rail having axial telescoping movement. The rail member 150 includes a first rail 252, a second rail 254, and a third rail 256. The first rail 252 to receive a first cage 120. The second rail 254 to receive a second cage 130. The third rail 256 to connect to a chassis. The rail member 150 to move the first cage 120 and the second cage 130 along the rail member 150 between an installed position P_{I} illustrated in FIG. 2, an access position P_{A} illustrated in FIGS. 3A-3B, and a transitional position P_{T} illustrated in FIG. 4.

FIGS. 2-4 illustrate the motion of the mounting assembly 100 based on movement of the rail member 150. Referring to FIG. 2 illustrates the mounting assembly 100 in an installed position, P_{I}. The installed position, P_{I}, illustrates the position of the mounting assembly 100 as it would be installed, for example, in a chassis during normal operation of a computing system. In the installed position, P_{I}, the first cage 120 is accessible. For example, the electronic component may be hot pluggable and access to the electronic components may be provided through the front of the chassis while the electronic components are in operation.

In the installed position, P_{I}, the first cage 120 and the second cage 130 are adjacent to one another with the rail member 150 in a retracted or nested position, R_{C}. In the retracted position, R_{C}, the first rail 252, the second rail 254, and the third rail 256 are nested in one another. The latch member 170 may hold the rail member 150 in the retracted position, R_{C}, and release the rail member 150 to enable movement to an access position, P_{A}.

The latch member 170 to retain the first cage 120 and the second cage 130 in the installed position, P_{I}. The latch member 170 includes a lever member 272, such as a tab, and an engagement member 274, such as a hook. The lock mechanism 190 to hold the second cage 130 in the access position. The lock mechanism 190 is not engaged.

FIG. 3A illustrates the mounting assembly 100 in an access position, P_{A}. The access position, P_{A}, illustrates the position of the mounting assembly 100 as it would be positioned to access the second cage 130. In the access position P_{A}, the first cage 120 and the second cage 130 are accessible. In other words, the electronic components of the first cage 120 and/or the second cage 130 may be accessed for purposes of repair, replacement, removal, and/or installation. Since these may be hot pluggable devices, the repair, replacement, removal, and/or installation may be performed while the electronic system is in operation.

In the access position, P_{A}, the first cage 120 and the second cage 130 are spaced apart from one another with the rail member 150 in an extended position, R_{E}. In the extended position, R_{E}, the first rail 252 is illustrated as extending from the second rail 254 to move the first cage 120 a first distance, D₁, and the second rail 254 is illustrated as extending from the third rail 356 to move the second cage 130 a second distance, D₂, which reduces the overlapping or nesting of the first rail 252, the second rail 254, and the third rail 256.

In the extended position, R_{E}, the lock mechanism 190 is visible between the first and second rail members 252, 254. An enlarged view of the lock mechanism 190 is illustrated in FIG. 3B. For example, the lock mechanism 190 is illustrated as a snaplock that engages or locks when the first and second cages 120, 130 are spaced apart from one another in the access position, P_{A}, and the first and second rail members 252, 254 are fully extended, i.e., in the extended position, R_{E}. The lock mechanism 190 may include a protrusion 392 and an aperture 394. The protrusion 392 and the aperture 394 to retain the rail member 150 when the protrusion 392 engages with the aperture 394. The protrusion 392 and the aperture 394 to release the rail member 150 when the protrusion 392 and aperture 394 are unengaged.

Referring to FIGS. 3A-3B, the lock mechanism 190 is illustrated as a protrusion 392 or tab extending from the second rail member 254. The protrusion 392 engages with an aperture 394 formed in the first rail 252. At least one protrusion 392 and at least one aperture 394 may form the lock mechanism 190. The engagement between the protrusion 392 and the aperture 394 retains the first rail 252 in the extended position R_{E}. For example, the protrusion 392 may include a spring loaded protrusion that retains the rail member 150 when the protrusion 392 engages with and remains within the aperture 394.

To release the lock mechanism 190, a release force, F_{R}, may be applied to the spring loaded protrusion 392. The release force, F_{R}, to release the engagement between the protrusion 392 and aperture 396. The release of engagement between the protrusion 394 and the aperture 396 allows the first rail 252 to move from the extended position R_{E} back to the retracted position, R_{C}. Movement of the rail member 150 to the retracted position, R_{C}, may occur when a horizontal force, F_{H} is applied to the first cage 120 and/or the first rail 152. For example, the horizontal force, F_{H}, may include a spring member that pulls the first rail 152 and the second rail member 154 together. Alternatively, the horizontal force, F_{H}, may include a user applying a force to the first cage 120 and/or first rail 152 to move the rail member 150 back to the retracted position, R_{C}.

Release of the lock mechanism 190 allows the mounting assembly 100 to move from the access position, P_{A}, back to the installed position, P_{I}. As the first cage 120 and the second cage 130 are moved towards the installed position, P_{I}, the cages meet in a transitional position, P_{T}. FIG. 4 illustrates the mounting assembly 100 in a transitional position, P_{T}. In the transitional position, P_{T}, the first cage 120 and the second cage 130 are adjacent to one another with the second rail 254 of the rail member 150 in an extended position, R_{E}, and the first rail 252 of the rail member 150 in a retracted position, R_{C}.

The rigid cable member 160 to move with the first cage 120 and the second cage 130 along the rail member 150. For example, FIG. 2 illustrates the rigid cable member 160 aligned with the first cage 120 and the second cage 130. In the installed position, P_{I}, the rigid cable member 160 extends across the first cage 120 and the second cage 130 and extends beyond the second cage 130 such that it may extend into a chassis. Referring to FIG. 3A, the rigid cable member 160 moves or slides with the first cage 120 and the second cage 130 as the cages move to the access position, P_{A}. In the access position, P_{A}, the rigid cable member 160 extends between the first and the second cage 120, 130 as illustrated in FIG. 3. Referring to FIG. 4, the rigid cable member 160 moves with the first cage 120 to the transitional position, P_{T}. In the transitional position, P_{T}, the rigid cable member 160 extends across the first cage 120 and the second cage 130 and beyond the second cage 130.

The rigid cable member 160 is aligned with the first cage 120 and the second cage 130 in a similar manner in the installed position, P_{I}, (FIG. 2) and the transitional position, P_{T}, (FIG. 4); however, the position of the rigid cable member 160 with respect to the rail member 150 is different. For example, in FIG. 2 the rigid cable member 160 extends past the third rail 256 of the rail member 150. In FIG. 4, the rigid cable member 160 extends across a portion of the third rail 256 since the second cage 130 is in an extended position. The difference between FIGS. 2 and 4 is that the rigid cable member 160 will remain the same length and move as a unitary body with the first cage 120 and the second cage 130 as the first rail 252, the second rail 254, and the third rail 256 of the rail member 150 retract in an axial telescoping movement as the first cage 120 and the second cage 130 move along the third rail 256 between the transitional position, P_{T}, of FIG. 4 and the installed position, P_{I} of FIG. 2.

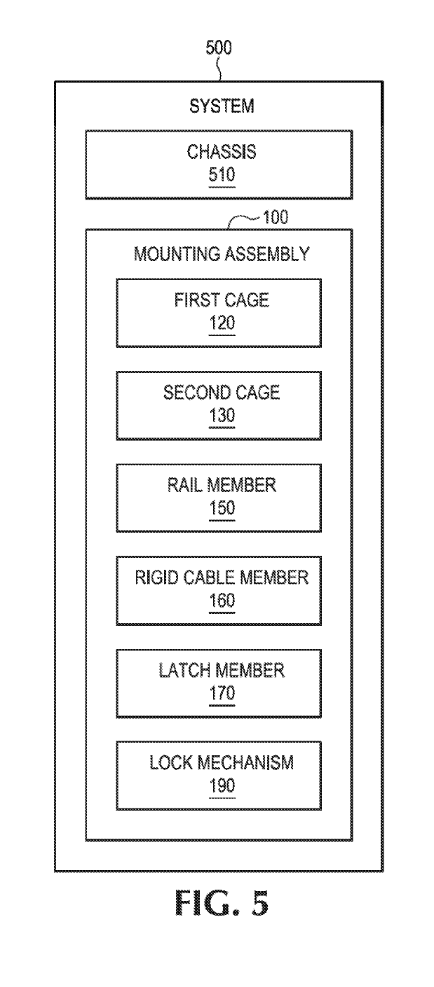

FIG. 5 illustrates a block diagram of a system 500 according to an example. The system 500 includes a chassis 510 and a mounting assembly 100. The chassis 510 to receive a cage. The mounting assembly 100 to mount to the chassis 510. For example, the mounting assembly 100 may be used to mount the chassis 510 with a cage and provide access thereto.

The mounting assembly includes a first cage 120, a second cage 130, a rail member 150, a rigid cable member 160, a latch member 170, and a lock mechanism 190. The rail member 150 includes a first rail 252, a second rail 254, and a third rail 256. The first rail 252 to receive the first cage 120. The second rail 254 to receive the second cage 130. The third rail 256 to connect to a chassis 510. The first rail 252 to extend from the second rail 254 and move the first cage 120 a first distance, D₁. The second rail 254 to extend from the third rail 256 and move the second cage 130 a second distance, D₂. The rigid cable member 160 to receive a cable and move with the first cage 120 and the second cage 130 along the rail member 150. The latch member 170 to retain the first cage 120 and the second cage 130 in the chassis 510. The lock mechanism 190 to hold the second cage 130 in an extended position.

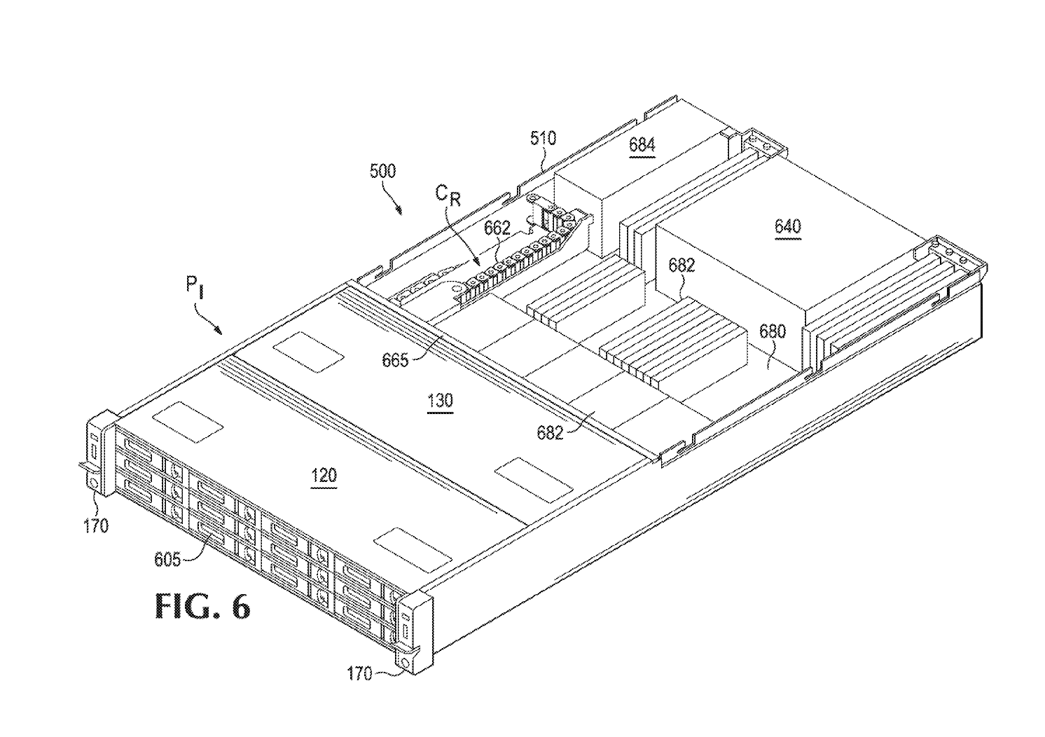

FIGS. 6-10 illustrate schematic views of the system 500 of FIG. 5 according to examples. The system 500 includes a chassis 510 and a mounting assembly 100 that moves between an installed position, P_{I}, an access position, P_{A}, and a transitional position, P_{T}.

The system 500 is illustrated with twelve large form factor hard disk drives 605 inserted in the first cage 120 and the second cage 130 for a total of twenty-four large form factor hot pluggable hard disk drives accessible via the front of the chassis 510. Access through the front of the chassis 510 provides a simple and easy way to access the hard disk drives without having to access the rear of the chassis 510. The system 500 may alternatively, include cages that each may hold fifteen large form factor hard disk drives to provide a system 500 with thirty large form factor disk drives accessible via the front of the chassis 510. Moreover, the system 500 may include additional components connected to the chassis 510, such as an additional cage 640; a backplane 665, circuitry 680, such as a circuit board; cooling devices 682, such as fans and/or heat sinks; and power supplies 864. Furthermore, since the system 500 is compatible with hot pluggable electronic components, the access may be provided without shutting down the whole electronic system.

Referring to FIG. 6, the system 500 is illustrated in the installed position, P_{I}. The installed position, P_{I}, illustrates the position of the mounting assembly 100 as it would be installed in the chassis 510 during normal operation of a computing system. In the installed position, P_{I}, the first cage 120 and the second cage 130 are adjacent to one another with the rail member 150 in a retracted or nested position, R_{C}. For example, the first rail 252, the second rail 254, and the third rail 256 of the rail member 150 are nested in one another.

The rigid cable member 160 moves with the first cage 120 and the second cage 130 along the rail member 150. The rigid cable member extends along the chassis 510 adjacent to the first cage 120 and the second cage 130. In the installed position, P_{I}, the rigid cable member 160 aligns with the first cage 120 and the second cage 130. In the installed position, P_{I}, the rigid cable member 160 extends across the first cage 120 and the second cage 130 and extends beyond the second cage 130 such that it may extend into a chassis 510 past the third rail 256.

The rigid cable member 160 is illustrated as a rectangular tube formed of sheet metal to receive cables connected to the first cage 120 and the second cage 130. The rigid cable member 160 may further include a flexible member 662 to move with the rigid cable member 160 and provide an additional range of motion as the mounting assembly 100 moves between the installed position, P_{I}, the access position, P_{A}, and the transitional position, P_{T}. For example, the flexible member 662 may include a chain formed to receive the cables. The flexible member 662 is illustrated within the chassis 510 in a retracted position, C_{R}, and may move with the cages. The flexible member 662 is illustrated in a retracted position, C_{R}, when the mounting assembly 100 is in the installed position, P_{I}, and moves to an extended position, C_{E}, when the mounting assembly 100 is in the access position, P_{A} and the transitional position, P_{T}.

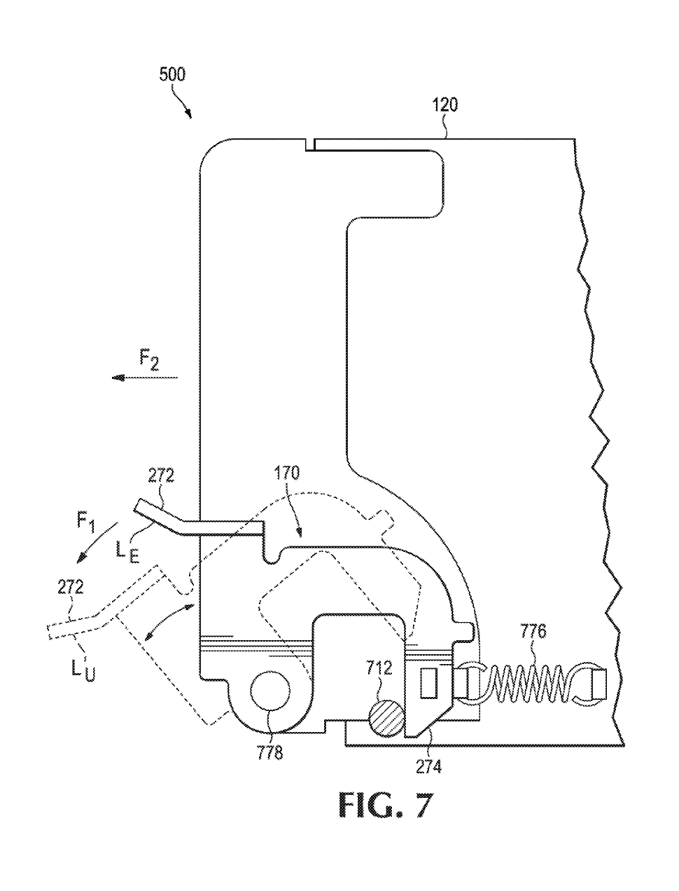

The latch member 170 retains the first cage 120 and the second cage 130 in the installed position, P_{I}. The latch member 170 includes a lever member 272, such as a tab, and an engagement member 274, such as a hook. An enlarged view of the latch member 170 is illustrated in FIG. 7. The lever member 272 may be moveably connected to the first cage 120 to allow a user to unengage the engagement member 274 and engage the engagement member 274 by applying a force, F₁, to the tab to control movement of the first cage 120 and/or the second cage 130 of the mounting assembly 100. For example, the latch member 170 may connect to the first cage 120 and/or the mounting assembly 100 via a fastener 778.

The latch member 170 moves between an engaged position, L_{E}, and an unengaged position, L_{U}. For example, the latch member 170 may engage with a portion of a chassis 510 such as a pin 712. The engagement member 274 may engages with pin 712 to hold the mounting assembly 100 therein when the latch member 170 is in the engaged position, L_{E}. Movement of the latch member 170 to the unengaged position, L_{U}, allows a second force, F₂, to be applied to the cage to move the cages 120 and 130 horizontally therein. The latch member 170 may further include a spring member 776 to retain the latch member 180 in the engaged position, L_{E}.

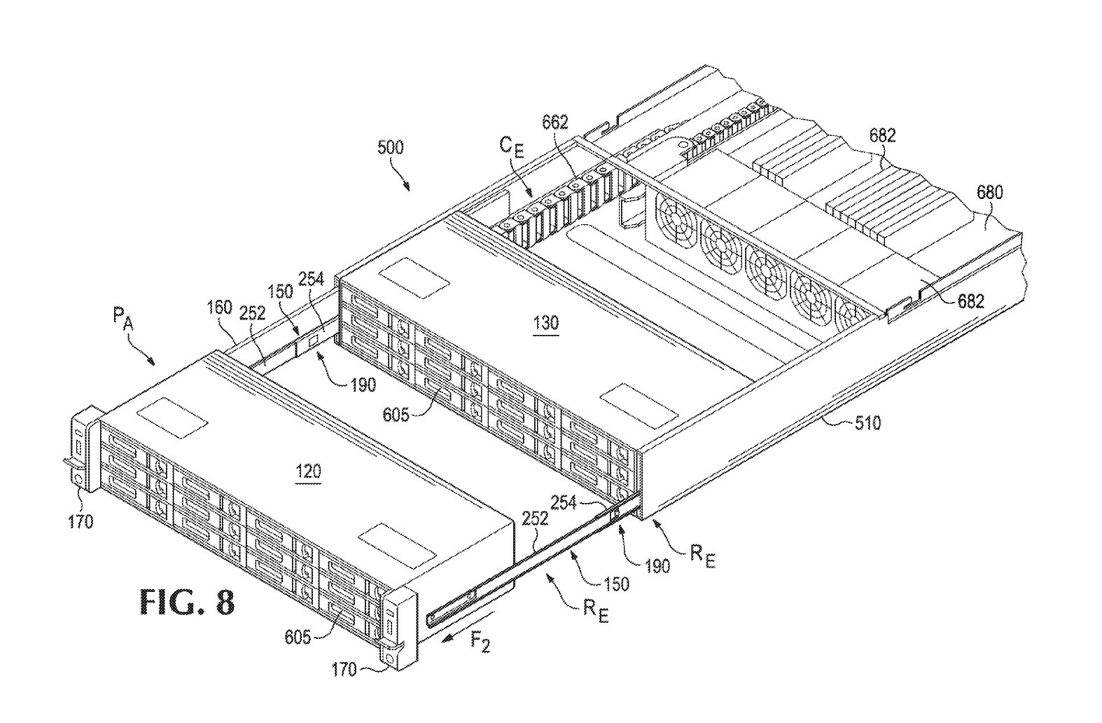

FIG. 8 illustrates the system 500 with the mounting assembly 100 in an access position, P_{A}. The access position, P_{A}, illustrates the position of the mounting assembly 100 as it would be positioned to access the second cage 130. In the access position, P_{A}, the first cage 120 and the second cage 130 are spaced apart from one another with the rail member 150 in an extended position, R_{E}. In the extended position, R_{E}, the third rail 256 remains within the chassis 510, the first rail 252 is illustrated as extending from the second rail 254 reducing the overlapping or nesting of the first rail 252, the second rail 254, and the third rail 256. For example, the first rail 252 is extended from the chassis 510 and the second rail 254 is extended within the chassis 510. The rigid cable member 160 moves or slides with the first cage 120 and the second cage 130 as the cages move to the access position, P_{A}. In the access position, P_{A}, the rigid cable member 160 extends between the first and the second cage 120, 130. The flexible member 662 is illustrated extended, i.e., in the extended position, C_{E}. The latch member 170 is illustrated unengaged, L_{U}.

The lock mechanism 190 retains the first rail 252 and the second rail 254 in the extended position, R_{E}. The lock mechanism 190 is illustrated as a protrusion 392 or tab extending from the second rail member 254. The protrusion 392 engages with an aperture 394 formed in the first rail 252. At least one protrusion 392 and at least one aperture 394 may form the lock mechanism 190. The engagement between the protrusion 392 and the aperture 394 retains the first rail member 252 in the extended position, R_{E}. For example, the protrusion 392 may include a spring loaded protrusion that retains the rail member 150 when the protrusion 392 engages with and remains within the aperture 394.

To release the lock mechanism 190, a release force, F_{R}, may be applied to the spring loaded protrusion 392. The release force, F_{R}, to release the engagement between the protrusion 392 and aperture 396. The release of engagement between the protrusion 394 and the aperture 396 allows the first rail 252 to move from the extended position, R_{E}, back to the retracted position, R_{C}. Movement of the rail member 150 to the retracted position, R_{C}, may occur when a horizontal force, F_{H}, is applied to the first cage 120 and/or the first rail member 152. For example, the horizontal force, F_{H}, may include a spring member that pulls the first rail member 152 and the second rail member 154 together. Alternatively, the horizontal force, F_{H}, may include a user applying a force to the first cage 120 and/or first rail member 152 to move the rail member 150 back to the retracted position, R_{C}.

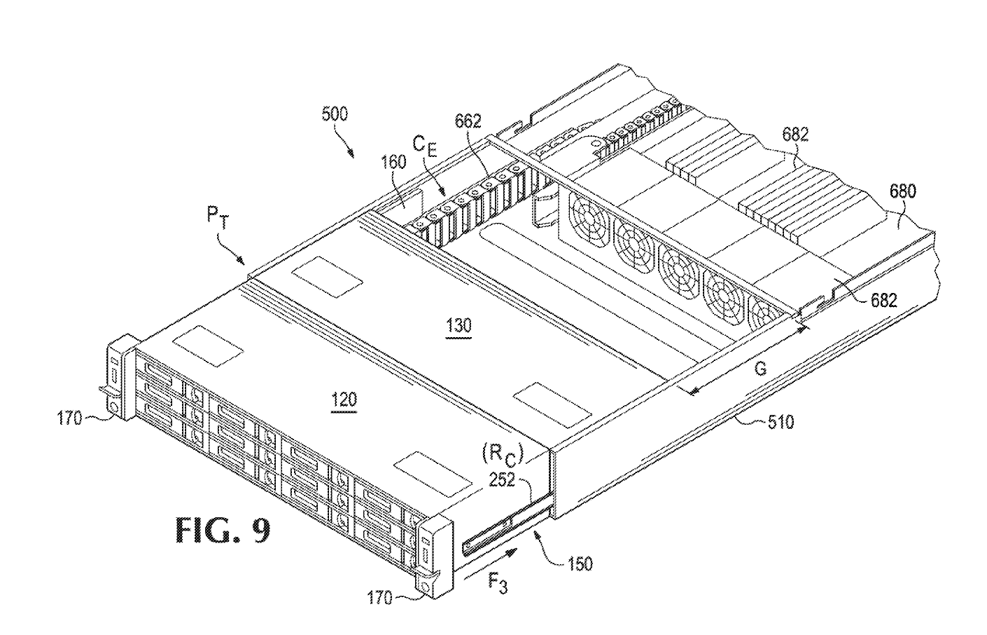

FIG. 9 illustrates the system 500 with the mounting assembly 100 in a transitional position, P_{T}. In the transitional position, P_{T}, the first cage 120 and the second cage 130 are adjacent to one another with the second rail 254 of the rail member 150 in an extended position, R_{E}, and the first rail 252 of the rail member 150 in a retracted position R_{C}. A gap, G, is formed between the second cage 130 and the back of the chassis 510, i.e. where the circuitry 680 and cooling devices 682 are located. With the rail member 150 in the retracted position, R_{C}, the lock mechanism 190 is not in use. In the retracted position, R_{C}, the first rail 252 is nested in the second rail 254. The second rail 254 is extended within the chassis 510 and remains at least partially within the chassis 510 with the second cage 130 connected thereto. The latch member 170 remains unengaged in the transitional position, P_{T}.

The rigid cable member 160 moves with the first cage 120 to the transitional position, P_{T}. In the transitional position, P_{T}, the rigid cable member 160 extends across the first cage 120 and the second cage 130 and beyond the second cage 130. The rigid cable member 160 extends across a portion of the third rail 256 and the flexible member 662 is illustrated extended, i.e., the extended position, C_{E}, since the second cage 130 is in an extended position. The difference between the transitional position, P_{T}, and the installed position, P_{I}, is that the rigid cable member 160 will remain the same length and move as a unitary body with the first cage 120 and the second cage 130 as the first rail 252, the second rail 254, and the third rail 256 of the rail member 150 retracts in an axial telescoping movement as the first cage 120 and the second cage 130 move along the third rail 256 between the transitional position, P_{T}, and the installed position, P_{I}.

Referring to FIGS. 6-9, the latch member 170 may control movement of the first cage 120 and the second cage 130 based on forces applied to the lever member 272. For example, in the installed position, P_{I}, a first force F₁, such as a vertical or downward force, may be applied to the lever member 272 to release the lever member 272 from the engagement portion 712. After the engagement member 274 releases, a second force F₂, such as a horizontal force, F_{H}, may be used to pull the first cage 120 out of the chassis 510 and move the second cage 130 to the front of the chassis 510 towards the access position, P_{A}. From the access position, P_{A}, a third force, F₃, such as a horizontal force from an direction opposite the second force, F₂, may be applied to push the first cage 120 back towards the second cage 130. The third force, F₃ allows the mounting assembly 100 to pass through the transitional position, P_{T}, and back into the installed position, P_{I}.

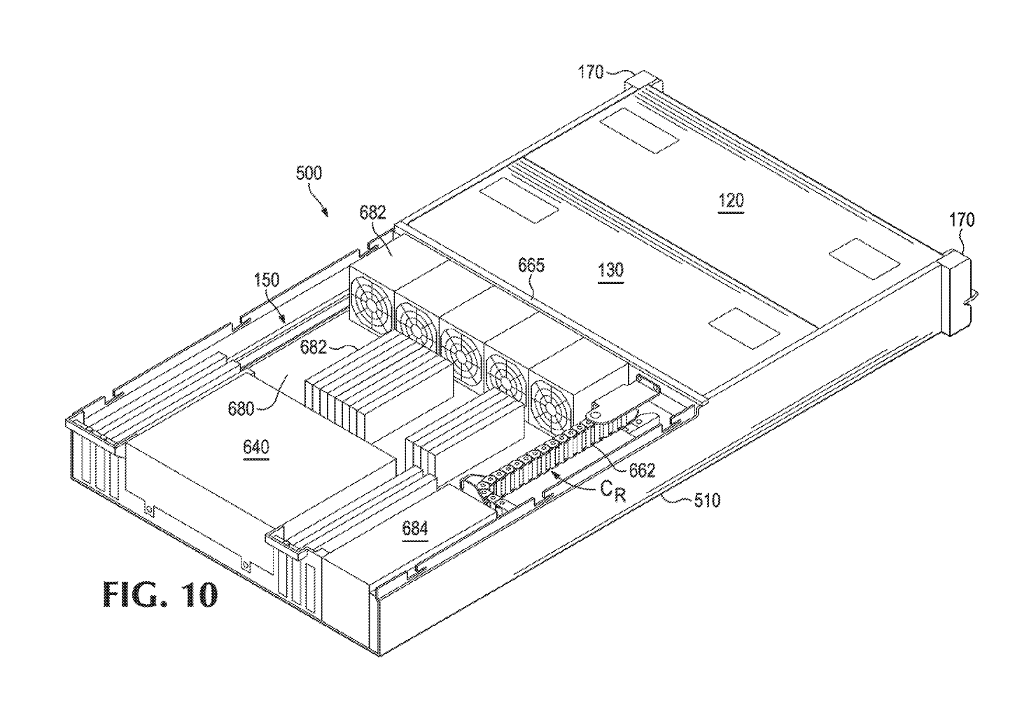

FIG. 10 illustrates a back view of the system 500 of FIG. 5 according to an example. The system 500 is illustrated to include a chassis 510 and a mounting assembly 100 that moves between an installed position, P_{I}, an access position, P_{A}, and a transitional position, P_{T}.

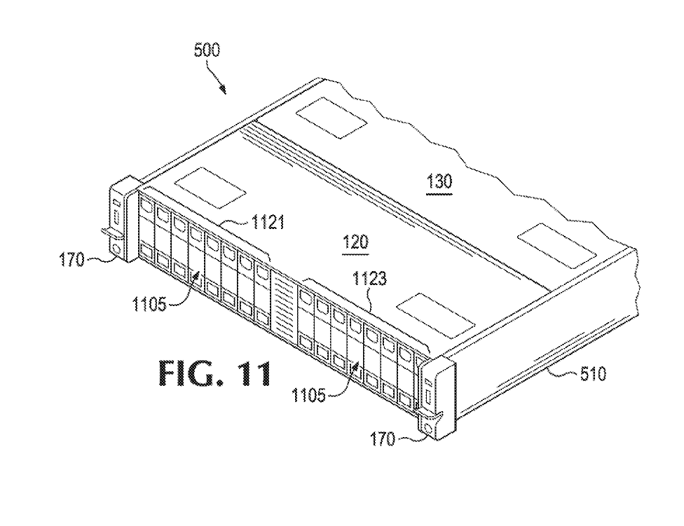

FIG. 11 illustrates an isometric view of the front of the system 500 of FIG. 5 according to an example. The system 500 includes a chassis 510 and a mounting assembly 100 that moves between an installed position, P_{I}, an access position, P_{A}, and a transitional position, P_{T}. The mounting system 100 includes the first cage 120, the second cage 130, the rail member 150, the rigid cable member 160, the latch member 170, and the lock mechanism 190. The first cage 120 and the second cage 130 are illustrated as having short form factor hard disk drives. For example, the first cage 120 includes two portions 1121 and 1123 each holding twelve short form factor hard disk drives 1105 for a total of twenty-four. The second cage 130 may similarly hold twenty-four short form factor hard disk drives accessible via the front of the chassis 510 using the mounting assembly 100 provided herein. Thus, the system 500 illustrated in FIG. 11 may hold up to forty-eight short form factor hard disk drives with access to the disk drives via the front of the chassis 510. Access to the disk drives are provided through the front of the chassis 510, which provides a simple and easy way to access the hard disk drives without having to access the rear of the chassis 510. Moreover, since the system 500 is compatible with hot pluggable electronic components, the access may be provided without shutting down the whole electronic system.

The present disclosure has been described using non-limiting detailed descriptions of examples thereof and is not intended to limit the scope of the present disclosure. It should be understood that features and/or operations described with respect to one example may be used with other examples and that not all examples of the present disclosure have all of the features and/or operations illustrated in a particular figure or described with respect to one of the examples. Variations of examples described will occur to persons of the art. Furthermore, the terms “comprise,” “include,” “have” and their conjugates, shall mean, when used in the present disclosure and/or claims, “including but not necessarily limited to.”

It is noted that some of the above described examples may include structure, acts or details of structures and acts that may not be essential to the present disclosure and are intended to be exemplary. Structure and acts described herein are replaceable by equivalents, which perform the same function, even if the structure or acts are different, as known in the art. Therefore, the scope of the present disclosure is limited only by the elements and limitations as used in the claims.

What is claimed is:

1. A mounting assembly comprising:
a first cage;
a second cage;
a telescoping rail member including a first rail, a second rail, and a third rail, the first rail to receive the first cage and slidably connected to the second rail, the second rail to receive the second cage and slidably connected to the third rail, and the third rail to connect to a chassis, the rail member to allow movement of the first cage and the second cage therealong between an installed position, an access position, and a transitional position;
a rigid cable member to move with the first cage and the second cage along the rail member;
a flexible member to move with the rigid cable member to provide additional range of motion;
a latch member to retain the first cage and the second cage in the installed position; and
a lock mechanism to hold the second cage in the access position.

2. The mounting assembly of claim 1, wherein the lock mechanism includes a protrusion and an aperture to retain the rail member when the protrusion engages with the aperture and release the rail member when the protrusion and aperture are unengaged.

3. The mounting assembly of claim 1, wherein in the access position the first cage and the second cage are spaced apart from and not in contact with one another.

4. The mounting assembly of claim 1, wherein in the installed position, the first cage and the second cage are adjacent to one another with the rail member in a retracted position.

5. The mounting assembly of claim 1, wherein in the transitional position, the first cage and the second cage are adjacent to one another with the second rail of the rail member in an extended position and the first rail of the rail member in a retracted position.

6. The mounting assembly of claim 1, wherein the latch member moves between an engaged position and an unengaged position.

7. The mounting assembly of claim 1, wherein the latch member includes a lever member and an engagement member.

8. A system comprising:
a chassis to receive an electronic component; and
a mounting assembly to mount to the chassis, the mounting assembly including:
a first cage;
a second cage;
a telescoping rail member including a first rail, a second rail, and a third rail, the first rail to receive the first cage and slidably connected to the second rail, the second rail to receive the second cage and slidably connected to the third rail, and the third rail to connect to the chassis, the rail member is to expand in a first direction such that, while expanding, the first rail slides relative to the second rail in the first direction and the second rail slides relative to the third rail in the first;
a rigid cable member to receive a cable and move with the first cage and the second cage along the rail member;
a flexible member to move with the rigid cable member to provide additional range of motion;
a latch member to retain the first cage and the second cage in the chassis; and
a lock mechanism to hold the second cage in an extended position.

9. The system of claim 8, wherein, as the rail member expands in the first direction, the first and second cages move between an installed position and an access position, with a transitional position in between.

10. The system of claim 9, wherein in the installed position the first rail, the second rail, and the third rail are nested together and located within the chassis.

11. The system of claim 9, wherein in the access position, the first rail is extended relative to the second rail and the first cage is located outside of from the chassis and the second rail is extended relative to the third rail and the second cage is located within the chassis.

12. The system of claim 9, wherein in the transitional position, the first rail is nested in the second rail and located within the chassis and the second rail is extended relative to the third rail and located within the chassis.

13. The system of claim 8, wherein the latch member engages with a portion of the chassis.

14. The system of claim 8, wherein the lock mechanism includes a protrusion and an aperture to engage with each other to retain the rail member when the mounting assembly is in the access position and to disengage and release the rail member when the mounting assembly moves to the transitional position.

15. The system of claim 8, wherein the rigid cable member extends between the chassis and the mounting assembly.
